(19) United States
(12) Patent Application Publication
(10) Pub. No.: US 2012/0300941 A1
(43) Pub. Date: Nov. 29, 2012

(54) APPARATUS AND METHOD FOR REMOVING VOCAL SIGNAL

(75) Inventors: Hwan SHIM, Yongin-si (KR); Sun-min KIM, Yongin-si (KR); Young-tae KIM, Seongnam-si (KR)

(73) Assignee: SAMSUNG ELECTRONICS CO., LTD., Suwon-si (KR)

(21) Appl. No.: 13/480,812

(22) Filed: May 25, 2012

Related U.S. Application Data
(60) Provisional application No. 61/489,788, filed on May 25, 2011.

(30) Foreign Application Priority Data
May 7, 2012 (KR) 10-2012-0048318

(51) Int. Cl. H04R 5/00

(52) U.S. Cl. 381/1

(57) ABSTRACT

A method of removing a vocal signal is provided, the method including: extracting a difference signal between an input left signal and an input right signal of a stereo signal; obtaining left panning information of the input left signal from the input left signal, and right panning information of the input right signal from the input right signal; and generating an output left signal by applying the left panning information to the difference signal, and an output right signal by applying the right panning information to the difference signal.

### CROSS-REFERENCE TO RELATED PATENT APPLICATION

This application claims the benefit of U.S. Patent Application No. 61/489,788, filed on May 25, 2011, in the U.S. Patent and Trademark Office, and claims priority from Korean Patent Application No. 10-2012-0048318, filed on May 7, 2012, in the Korean Intellectual Property Office, the disclosures of which are incorporated herein in their entirety by reference.

### BACKGROUND

1. Field

Apparatuses and methods consistent with exemplary embodiments relate to an apparatus and method of removing a vocal signal, and more particularly, to an apparatus and method of removing a vocal signal from a stereo signal.

2. Description of the Related Art

Music signals not only include vocal signals containing voices of people, but also include various musical instrument signals. In other words, the music signals are a mix of various signals, such as vocal signals, piano signals, drum signals, and guitar signals.

The music signals may be represented by mono signals and stereo signals, wherein a stereo signal includes a right signal and a left signal. The stereo signal is not only included in a two-channel signal, but also included in a multi-channel signal (5.1 or 7.1 channel signal). In other words, the multi-channel signal consists of a center channel and several pairs of two-channel stereo signals (left front, right front, left surround, and right surround signals, etc.), excluding a sub-woofer channel.

A music producer may pan a vocal signal, a piano signal, or a drum signal to right and left signals at different energy ratios so that a listener of a stereo signal may sense a three-dimensional (3D) effect.

Recently, music recorded (MR) signals are widely used as accompaniments, and in order to generate an MR signal from a stereo signal, a vocal signal needs to be effectively removed from the stereo signal.

FIG. 1 is a diagram for describing a conventional method of removing a vocal signal. Generally, a vocal signal is panned to a left signal l(t) and a right signal r(t) at an equal energy ratio. Thus, the conventional method removes the vocal signal by transmitting the left and right signals l(t) and r(t) of a stereo signal to an adder-subtractor 10 so as to extract a difference signal y(t) between the left and right signals l(t) and r(t).

However, the difference signal y(t) output according to the conventional method is a mono signal, and thus, does not have characteristics of a stereo signal generated for a listener to sense a 3D effect. Accordingly, a method of effectively removing a vocal signal from a stereo signal and maintaining a 3D effect applied to the stereo signal in an output signal is desired.

### SUMMARY OF THE INVENTION

One or more exemplary embodiments may provide an apparatus and method of removing a vocal signal in large quantity from a stereo signal.

One or more exemplary embodiments may also provide an apparatus and method of removing a vocal signal, wherein a three-dimensional (3D) effect applied to a stereo signal is maintained in an output signal obtained by removing a vocal signal from the stereo signal.

According to an aspect of an exemplary embodiment, there is provided a method of removing a vocal signal, the method including: extracting a difference signal between an input left signal and an input right signal of a stereo signal; obtaining left panning information of the input left signal from the input left signal, and right panning information of the input right signal from the input right signal; and generating an output left signal by applying the left panning information to the difference signal, and an output right signal by applying the right panning information to the difference signal.

The obtaining of the left and right panning information may include: dividing each of the input left signal and the input right signal into a plurality of frequency bands in the frequency domain; and obtaining the left panning information according to the frequency bands of the input left signal, and obtaining the right panning information according to the frequency bands of the input right signal.

The generating of the output left signal and the output right signal may include generating the output left signal by applying the left panning information to the difference signal according to frequency bands of the difference signal, and the output right signal by applying the right panning information to the difference signal according to the frequency bands of the difference signal.

The obtaining of the left and right panning information may include: extracting a center signal of the stereo signal by using a cross correlation between the input left signal and the input right signal, the input left signal, and the input right signal; obtaining a first left signal constituting a difference signal between the input left signal and the center signal, and a first right signal constituting a difference signal between the input right signal and the center signal; dividing each of the first left signal and the first right signal into a plurality of frequency bands in the frequency domain; and obtaining the left panning information according to the frequency bands of the first left signal, and the right panning information according to the frequency bands of the first right signal.

The generating of the output left signal and the output right signal may include: generating a second left signal by applying the left panning information to the difference signal according to frequency bands of the difference signal, and a second right signal by applying the right panning information to the difference signal according to the frequency bands of the difference signal; and generating the output left signal by adding the first left signal to the second left signal at a predetermined ratio, and the output right signal by adding the first right signal to the second right signal at a predetermined ratio.

The method may further include extracting a percussion signal from the center signal, wherein the generating of the output left signal and the output right signal may include generating the output left signal by adding the percussion signal to a signal output by applying the left panning information to the difference signal according to the frequency bands of the difference signal, and the output right signal by adding the percussion signal to a signal output by applying the right panning information to the difference signal according to the frequency bands of the difference signal.

The extracting of the percussion signal may include: obtaining an intermediate value of an amplitude value of the center signal; and extracting a signal having an amplitude value higher than the intermediate value from among the center signal in the time domain, or a signal having an amplitude value smaller than the intermediate value from among the center signal in the frequency domain, as the percussion signal.

The extracting of the difference signal may include: determining whether an amplitude value of the difference signal is 0; if the amplitude value of the difference signal is 0, determining whether amplitude values of the input left signal and the input right signal correspond to a maximum or minimum value of a dynamic range; if the amplitude values of the input left signal and the input right signal correspond to the maximum or minimum value of the dynamic range, applying at least one of the input left signal and the input right signal to a smoothing filter; and extracting a difference signal between the input left signal and the input right signal.

The extracting of the difference signal may include: determining whether an amplitude value of the difference signal is 0; if the amplitude value of the difference signal is 0, determining whether amplitude values of the input left signal and input right signal correspond to a maximum or minimum value of a dynamic range; and if the amplitude values of the input left signal and input right signal correspond to the maximum or minimum value of the dynamic range, applying the difference signal to a smoothing filter.

The obtaining of the left and right panning information may include obtaining the left and right panning information by applying at least one of autoregressive (AR) processing, linear predictive coding (LPC), and principal component analysis (PCA) to the input left and right signals.

According to an aspect of another exemplary embodiment, there is provided an apparatus for removing a vocal signal, the apparatus including: an extractor for extracting a difference signal between an input left signal and an input right signal of a stereo signal; an information obtainer for obtaining left panning information of the input left signal from the input left signal, and right panning signal of the input right signal from the input right signal; and an output unit for generating an output left signal by applying the left panning information to the difference signal, and an output right signal by applying the right panning information to the difference signal.

The information obtainer may include: a frequency band divider for dividing each of the input left signal and the input right signal into a plurality of frequency bands in the frequency domain; and a panning information obtainer for obtaining the left panning information according to the frequency bands of the input left signal and the right panning information according to the frequency bands of the input right signal.

The output unit may generate the output left signal by applying the left panning information to the difference signal according to frequency bands of the difference signal, and the output right signal by applying the right panning information to the difference signal according to the frequency bands of the difference signal.

The information obtainer may extract a center signal of the stereo signal by using a cross correlation between the input left signal and the input right signal, the input left signal, and the input right signal, and may further include: a center signal remover for obtaining a first left signal constituting a difference signal between the input left signal and the center signal, and a first right signal constituting a difference signal between the input right signal and the center signal; a frequency band divider for dividing each of the first left signal and the first right signal into a plurality of frequency bands in the frequency domain; and a panning information obtainer for obtaining the left panning information according to the frequency bands of the first left signal and the right panning information according to the frequency bands of the first right signal.

The output unit may include: a panning information applier for generating a second left signal by applying the left panning information to the difference signal according to frequency bands of the difference signal, and a second right signal by applying the right panning information to the difference signal according to the frequency bands of the difference signal; and an adder-subtractor for generating the output left signal by adding the first left signal to the second left signal at a predetermined ratio, and the output right signal by adding the first right signal to the second right signal at a predetermined ratio.

The center signal remover may include a percussion signal extractor for extracting a percussion signal from the center signal, wherein the output unit may include an adder-subtractor for generating the output left signal by adding the percussion signal to a signal output by applying the left panning information to the difference signal according to frequency bands of the difference signal, and the output right signal by adding the percussion signal to a signal output by applying the right panning information to the difference signal according to the frequency bands of the difference signal.

The percussion signal extractor may obtain an intermediate value of an amplitude value of the center signal, and extract a signal having an amplitude value higher than the intermediate value from the center signal in the time domain, or a signal having an amplitude value smaller than the intermediate value from the center signal in the frequency domain, as the percussion signal.

The extractor may include: a determiner for determining whether an amplitude value of the difference signal is 0, and if the amplitude value of the difference signal is 0, determining whether amplitude values of the input left signal and input right signal correspond to a maximum or minimum value of a dynamic range; and a filter unit for, if the amplitude values of the input left signal and input right signal correspond to the maximum or minimum value of the dynamic range, smoothening at least one of the input left signal and the input right signal, and extracting a difference signal between the input left signal and the input right signal.

The extractor may include: a determiner for determining whether an amplitude value of the difference signal is 0, and if the amplitude value of the difference signal is 0, determining whether amplitude values of the input left signal and input right signal correspond to a maximum or minimum value of a dynamic range; and a filter unit for, if the amplitude values of the input left signal and input right signal correspond to the maximum or minimum value of the dynamic range, smoothening the difference signal.

The information obtainer may obtain the left panning information and the right panning information by applying at least one of autoregressive (AR) processing, linear predictive coding (LPC), and principal component analysis (PCA) to the input left and right signals.

According to an aspect of another exemplary embodiment, there is provided a computer-readable recording medium having recorded thereon a program for executing the method of above.

The input left and right signals of the stereo signal may include an input left front signal and an input right front signal of a multi-channel signal, or an input left surround signal and an input right surround signal.

The input left and right signals of the stereo signal may include an input left front signal and an input right front signal of a multi-channel signal, and may further include removing a signal of a predetermined frequency range included in a center channel signal of the multi-channel signal by applying a bandpass filter to the center channel signal.

### BRIEF DESCRIPTION OF THE DRAWINGS

The above and other exemplary aspects and advantages will become more apparent by describing in detail exemplary embodiments with reference to the attached drawings in which:

FIG. 1 is a diagram for describing a conventional method of removing a vocal signal;

FIG. 2 is a block diagram of an apparatus for removing a vocal signal, according to an exemplary embodiment;

FIG. 3 is a block diagram of an apparatus for removing a vocal signal, according to another exemplary embodiment;

FIG. 4 is a block diagram of an apparatus for removing a vocal signal, according to another exemplary embodiment;

FIGS. 5A and 5B are graphs for describing a method of extracting a percussion signal from a center signal;

FIGS. 6A through 6C are diagrams respectively showing an input left signal to which a dynamic compression is applied, an input right signal to which a dynamic compression is applied, and a difference signal between the input left signal and the input right signal;

FIGS. 7A through 7C are diagrams for describing a method of compensating for a difference signal, according to another exemplary embodiment;

FIGS. 8A and 8B are diagrams for describing a method of compensating for a difference signal, according to another exemplary embodiment;

FIG. 9 is a flowchart illustrating a method of removing a vocal signal, according to an exemplary embodiment; and

FIG. 10 is a flowchart illustrating a method of removing a vocal signal, according to another exemplary embodiment.

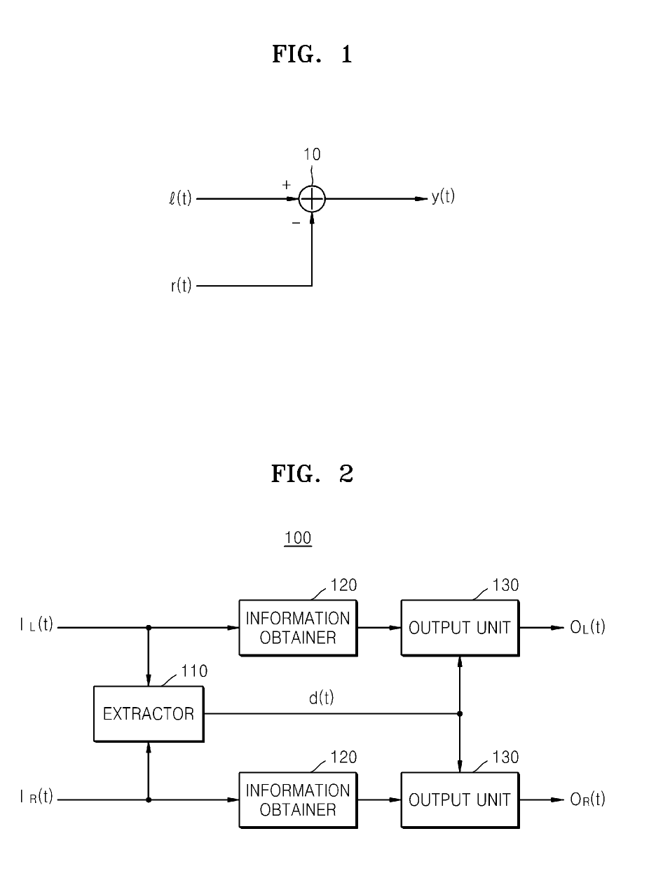

### DETAILED DESCRIPTION OF THE INVENTION

Exemplary embodiments will now be described more fully with reference to the accompanying drawings. The exemplary embodiments, however, should not be construed as being limited to the descriptions set forth herein; rather, these descriptions are provided so that this disclosure will be thorough and complete, and will fully convey the concept exemplary embodiments to one of ordinary skill in the art. Like reference numerals in the drawings denote like elements, and thus their description will be omitted.

The term ‘unit’ in the embodiments means a software component or hardware components such as a field-programmable gate array (FPGA) or an application-specific integrated circuit (ASIC), and performs a specific function. However, the term ‘unit’ is not limited to software or hardware. The ‘unit’ may be formed so as to be in an addressable storage medium, or may be formed so as to operate one or more processors. Thus, for example, the term ‘unit’ may refer to components such as software components, object-oriented software components, class components, and task components, and may include processes, functions, attributes, procedures, subroutines, segments of program code, drivers, firmware, micro codes, circuits, data, a database, data structures, tables, arrays, or variables. A function provided by the components and ‘units’ may be associated with the smaller number of components and ‘units’, or may be divided into additional components and ‘units’.

In the present specification, F(t) denotes a signal in the time domain t, and F(f) denotes a signal in the frequency domain f of the signal F(t). It would be obvious to one of ordinary skill in the art that F(t) and F(f) denote the same signal.

Also, in the present specification, a left signal and a right signal not only respectively include a left signal and a right signal of a two-channel, but also respectively include a left front signal and a right front signal in a multi-channel signal, or a left surround signal and a right surround signal.

FIG. 2 is a block diagram of an apparatus 100 for removing a vocal signal, according to an exemplary embodiment.

Referring to FIG. 2, the apparatus 100 may include an extractor 110, an information obtainer 120, and an output unit 130. The extractor 110, the information obtainer 120, and the output unit 130 may be realized as a microprocessor, and the output unit 130 may include a speaker that outputs an audio signal.

In FIG. 2, two information obtainers 120 and two output units 130 are shown for convenience of description, and it would be obvious to one of ordinary skill in the art that the information obtainers 120 and the output units 130 may be each realized as one module.

An input left signal I_{L}(t) and an input right signal I_{R}(t) of a stereo signal are input to the extractor 110. The input left signal I_{L}(t) and the input right signal I_{R}(t) may be signals stored in the apparatus 100, or signals input from an external server through wired or wireless communication.

The extractor 110 extracts a difference signal d(t) between the input left signal I_{L}(t) and the input right signal I_{R}(t). The difference signal d(t) may be extracted according to Equation 1 below.

d(t)=IL(t)−IR(t) [Equation 1]

Generally, since a vocal signal is panned to the input left signal I_{L}(t) and the input right signal I_{R}(t) of the stereo signal at equal energy ratios, the difference signal d(t) is a signal that does not include the vocal signal.

The information obtainer 120 obtains left panning information of the input left signal I_{L}(t) from the input left signal I_{L}(t), and right panning information of the input right signal I_{R}(t) from the input right signal I_{R}(t).

The information obtainer 120 may obtain panning information of signals by considering energy ratios of the signals panned to the input left signal I_{L}(t) or the input right signal I_{R}(t). Herein, “panning information” denotes energy ratios of several signals divided according to frequency bands panned to a left or right signal.

The information obtainer 120 may obtain the left panning information and the right panning information by applying at least one of autoregressive (AR) processing, linear predictive coding (LPC), and principal component analysis (PCA) on the input left signal I_{L}(t) and the input right signal I_{R}(t).

In detail, the information obtainer 120 may continuously update the left panning information and the right panning information by applying at least one of AR processing, LPC, and PCA on the input left signal I_{L}(t) and the input right signal I_{R}(t) that are input in real time.

The output unit 130 generates an output left signal O_{L}(t) by applying the left panning information to the input left signal I_{L}(t) and an output right signal O_{R}(t) by applying the right panning information to the input right signal I_{R}(t).

When P_{L}(t) denotes left panning information and P_{R}(t) denotes right panning information in the time domain, the output left signal O_{L}(t) and the output right signal O_{R}(t) may be generated according to Equation 2 below.

O_{L}(t)=I_{L}(t)*P_{L}(t)

O_{R}(t)=I_{R}(t)*P_{R}(t) [Equation 2]

In Equation 2, * denotes convolution.

Since the apparatus 100 according to an exemplary embodiment pans the difference signal d(t) to the output left signal O_{L}(t) and the output right signal O_{R}(t) by considering the left panning information and the right panning information of the input left signal I_{L}(t) and the input right signal I_{R}(t) of the stereo signal, a 3D effect of the stereo signal may be maintained.

When the stereo signal input to the extractor 110 is a multi-channel signal, the input left signal I_{L}(t) and the input right signal I_{R}(t) may respectively correspond to an input left front signal and an input right front signal in the multi-channel signal. Since a center channel signal of the multi-channel signal is a mono signal and may include a vocal signal, the apparatus 100 according to an exemplary embodiment may remove a signal in a predetermined frequency range corresponding to a frequency band of the vocal signal by applying the center channel signal to a bandpass filter (not shown). Accordingly, the vocal signal included in the center channel signal may be removed.

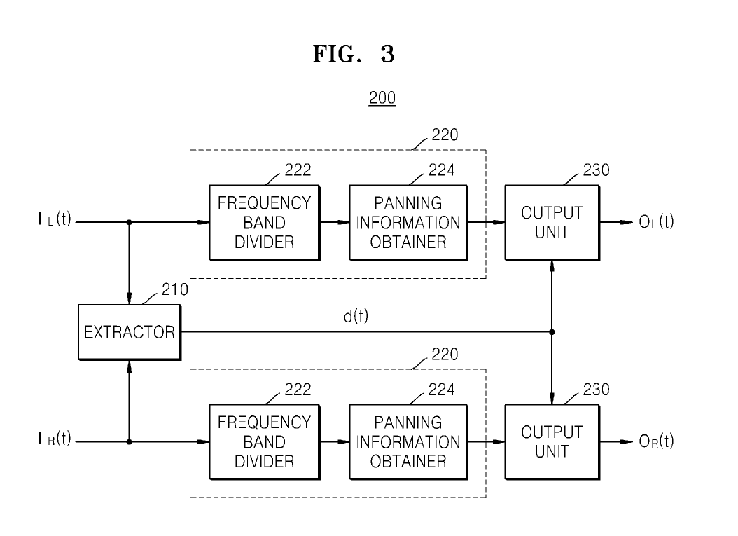

FIG. 3 is a block diagram of an apparatus 200 for removing a vocal signal, according to another exemplary embodiment.

An information obtainer 220 of the apparatus 200 of FIG. 3 may include a frequency band divider 222 and a panning information obtainer 224.

The frequency band divider 222 divides each of the input left signal I_{L}(t) and the input right signal I_{R}(t) into a plurality of frequency bands in the frequency domain. The frequency band divider 222 may include a module (not shown) that converts the input left signal I_{L}(t) and the input right signal I_{R}(t) to the frequency domain, and may divide the input left signal I_{L}(t) and the input right signal I_{R}(t) into a plurality of frequency bands according to a predetermined frequency range.

FIG. 3 shows that the input left signal I_{L}(t) and the input right signal I_{R}(t) in the time domain are input to the frequency band divider 222 and an extractor 210, but it is obvious to one of ordinary skill in the art that the input left signal I_{L}(t) and the input right signal I_{R}(t) may be input to the frequency band divider 222 and the extractor 210 after being converted to the frequency domain.

The panning information obtainer 224 may obtain left panning information according to the frequency bands of the input left signal I_{L}(t) and right panning information according to the frequency bands of the input right signal I_{R}(t).

Left panning information P_{L}(f) and right panning information P_{R}(f) in the frequency domain may be obtained according to Equation 3 below.

P_{L}(f)=|I_{L}(f)|/(|I_{L}(f)|+|I_{R}(f)|)

P_{R}(f)=|I_{R}(f)|/(|I_{L}(f)|+|I_{R}(f)|)

The left panning information P_{L}(f) and the right panning information P_{R}(f) may be obtained according to frequency bands by applying Equation 3 to the input left signal I_{L}(t) and the input right signal I_{R}(t) according to frequency bands, respectively.

For example, left panning information about a frequency band from 1 kHz to 1.5 kHz may be obtained by using an energy ratio of a signal included in the frequency band from 1 kHz to 1.5 kHz from among the input left signal I_{L}(t), and left panning information b about a frequency band from 1.5 kHz to 2 kHz may be obtained by using an energy ratio of a signal included in the frequency band from 1.5 kHz to 2 kHz from among the input left signal I_{L}(t).

Although not shown in FIG. 3, the apparatus 200 according to the current embodiment may further include a second frequency band divider that divides the difference signal d(t) between the input left signal I_{L}(t) and the input right signal I_{R}(t) into a plurality of frequency bands in the frequency domain. Alternatively, the difference signal d(t) may be divided into a plurality of frequency bands by the frequency band divider 222 of FIG. 3.

An output unit 230 may generate the output left signal O_{L}(t) by applying the left panning information to the difference signal d(t) in the frequency domain according to the frequency bands of the difference signal d(t), and the output right signal O_{R}(t) by applying the right panning information to the difference signal d(t) according to the frequency bands of the difference signal d(t). In detail, an output left signal O_{L}(f) and an output right signal O_{R}(f) in the frequency domain may be generated according to Equation 4 below.

O_{L}(f)=d(f)·P_{L}(f)

O_{R}(f)=d(f)·P_{R}(f) [Equation 4]

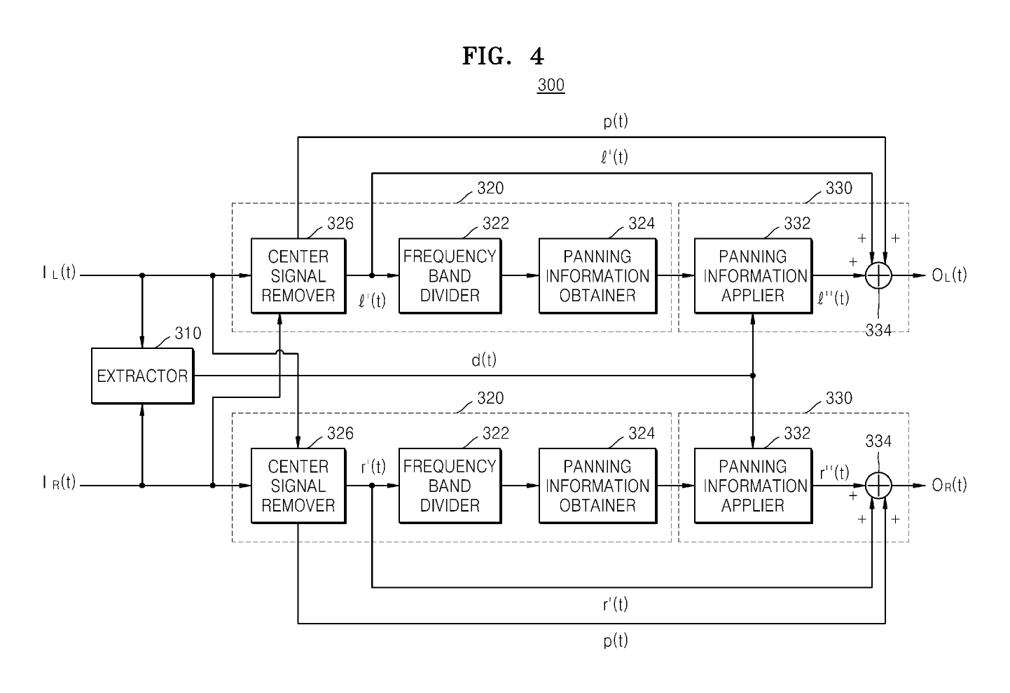

FIG. 4 is a block diagram of an apparatus 300 for removing a vocal signal, according to another exemplary embodiment.

Referring to FIG. 4, an information obtainer 320 may include a center signal remover 326, a frequency band divider 322, and a panning information obtainer 324, and an output unit 330 may include a panning information applier 332 and an adder-subtractor 334.

Each of the input left signal I_{L}(t) and the input right signal I_{R}(t) of the stereo signal includes a center signal m(t) including a vocal signal. Herein, a “center signal” denotes a signal panned to left and right signals of a stereo signal at equal energy ratios.

Since the input left signal I_{L}(t) and the input right signal I_{R}(t) include a vocal signal, as shown in FIG. 3, when the left panning information and the right panning information are respectively directly obtained from the input left signal I_{L}(t) and the input right signal I_{R}(t), the left and right panning information may include the vocal signal.

Accordingly, the apparatus 300 of FIG. 4 removes the center signal m(t) included in the input left signal I_{L}(t) and input right signal I_{R}(t), and obtains the left and right panning information by using the left and right signals from which the center signal m(t) is removed.

The center signal remover 326 obtains a cross correlation between the input left signal I_{L}(t) and the input right signal I_{R}(t), and extracts the center signal m(t) by using the cross correlation, the input left signal I_{L}(t), and the input right signal I_{R}(t).

In detail, a cross correlation Φ(t) between the input left signal I_{L}(t) and the input right signal I_{R}(t) may be obtained according to Equation 5 below.

Φ(t)=|E(I_{L}(t)I_{R}*(t))|/sqrt{E(I_{L}(t)I_{L}*(t))·E(I_{R}(t)I_{R}*(t))} [Equation 5]

The center signal m(t) may be extracted according to Equation 6 below.

m(t)=Φ(t)·{(I_{L}(t)+I_{R}(t))/2} [Equation 6]

The center signal remover 326 may obtain a first left signal l′(t) constituting a difference signal between the input left signal I_{L}(t) and the center signal m(t), and a first right signal r′(t) constituting a difference signal between the input right signal I_{R}(t) and the center signal m(t). The first left signal l′(t) and the first right signal r′(t) may be obtained according to Equation 7 below.

l′(t)=I_{L}(t)−m(t)

r′(t)=I_{R}(t)−m(t) [Equation 7]

The frequency band divider 322 divides each of the first left signal l′(t) and the first right signal r′(t) into a plurality of frequency bands in the frequency domain. In FIG. 4, the frequency band divider 322 is behind the center signal remover 326, but it is obvious to one of ordinary skill in the art that the frequency band divider 322 may be in front of the center signal remover 326.

The panning information obtainer 324 may obtain left panning information according to the frequency bands of the first left signal l′(t) and right panning information according to the frequency bands of the first right signal r′(t). The left and right panning information may be obtained according to Equation 3 above.

The output unit 330 may generate the output left signal O_{L}(t) by applying the left panning information to the difference signal d(t) according to the frequency bands of the difference signal d(t), and the output right signal O_{R}(t) by applying the right panning information to the difference signal d(t) according to the frequency bands of the difference signal d(t).

Also, the panning information applier 332 of the output unit 330 may generate a second left signal l″(t) by applying the left panning information to the difference signal d(t) according to the frequency bands of the difference signal d(t), and a second right signal r″(t) by applying the right panning information to the difference signal d(t) according to the frequency bands of the difference signal d(t), and transmit the second left signal l″(t) and second right signal r″(t) to the adder-subtractor 334.

The adder-subtractor 334 generates the output left signal O_{L}(t) by adding the first left signal l′(t) to the second left signal l″(t) at a predetermined ratio, and the output right signal O_{R}(t) by adding the first right signal r′(t) to the second right signal r″(t) at a predetermined ratio.

Accordingly, a 3D effect of an output signal may be improved compared to when an output signal is generated by applying panning information to a difference signal. A user may adjust the 3D effect of the output signal by adjusting the predetermined ratios.

The center signal m(t) extracted by the center signal remover 326 may include not only a vocal signal, but also musical instrument signals. A percussion signal p(t) generated by a percussion instrument, such as a drum, is generally panned to the left and right signals of the stereo signal at equal energy ratios, and thus, when the center signal m(t) is simply removed from the input left signal I_{L}(t) and input right signal I_{R}(t), the percussion signal p(t) may also be removed.

Although not shown in FIG. 4, the center signal remover 326 may include a percussion signal extractor.

The percussion signal extractor may extract and transmit the percussion signal p(t) from the center signal m(t) to the adder-subtractor 334.

The adder-subtractor 334 may generate the output left signal O_{L}(t) by adding the percussion signal p(t) and the difference signal d(t) to which the left panning information is applied, and the output right signal O_{R}(t) by adding the percussion signal p(t) and the difference signal d(t) to which the right panning information is applied. Alternatively, the adder-subtractor 334 may generate the output left signal O_{L}(t) by adding the first left signal l′(t), the second left signal l″(t), and the percussion signal p(t), and the output right signal O_{R}(t) by adding the first right signal r′(t), the second right signal r″(t), and the percussion signal p(t).

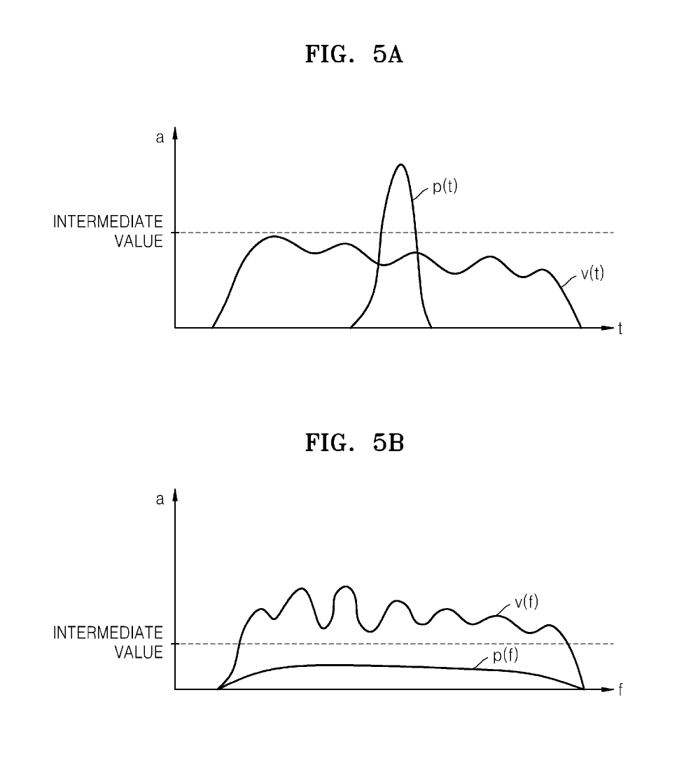

FIGS. 5A and 5B are graphs for describing a method of extracting a percussion signal p(t) from a center signal m(t).

FIG. 5A is a graph showing the center signal m(t) in the time domain, and FIG. 5B is a graph showing the center signal m(t) in the frequency domain. It is assumed that the center signal m(t) includes a vocal signal v(t) and the percussion signal p(t).

Generally, the percussion signal p(t) has a high amplitude for a short period of time in the time domain. In the frequency domain, the percussion signal p(t) has a wide frequency range and a low amplitude.

First, a percussion signal extractor obtains an intermediate value of an amplitude value of the center signal m(t) in the time or frequency domain.

The percussion signal extractor may extract a signal having an amplitude value higher than the intermediate value from among the center signal m(t) as the percussion signal p(t) in the time domain, and a signal having an amplitude value smaller than the intermediate value from among the center signal m(t) as the percussion signal p(t) in the frequency domain. The percussion signal p(t) may be extracted by the intermediate value shown in FIGS. 5A and 5B.

As described above with reference to FIG. 2, the extractor 110 may extract the difference signal d(t) between the input left signal IL(t) and the input right signal IR(t).

Generally, a music producer amplifies left and right signals of a stereo signal and applies dynamic compression on the left and right signals according to dynamic ranges of the left and right signals, so as to increase an intensity of the stereo signal.

When the difference signal d(t) is extracted by using the input left signal IL(t) and the input right signal IR(t), to which dynamic compression is applied, an amplitude value of the difference signal d(t) may be 0. Accordingly, even if panning information is applied to the extracted difference signal d(t), the output left signal OL(t) and the output right signal OR(t) are not accurately generated.

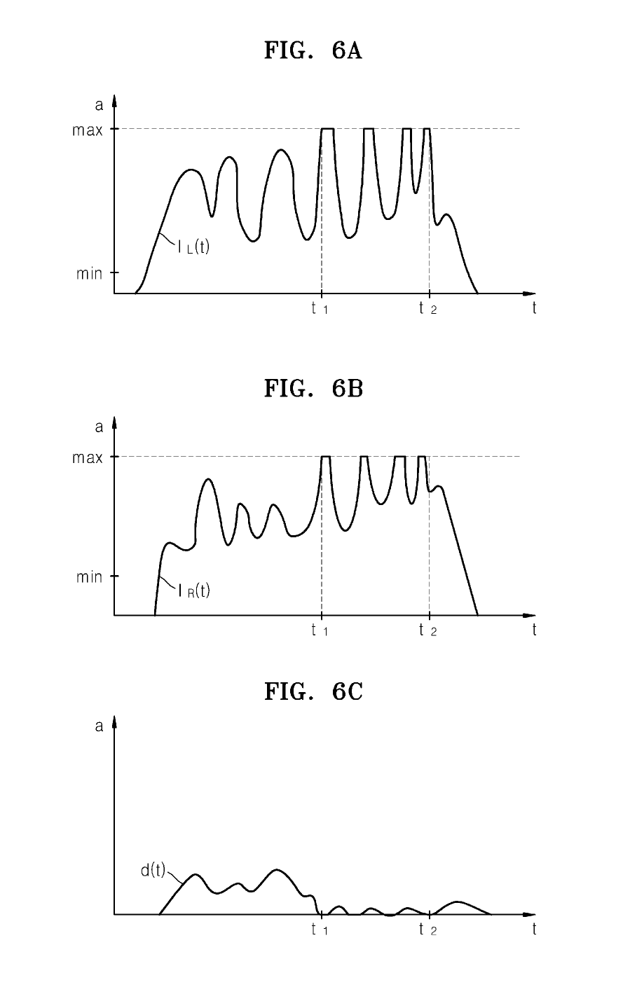

FIGS. 6A through 6C are diagrams respectively showing an input left signal IL(t) to which a dynamic compression is applied, an input right signal IR(t) to which a dynamic compression is applied, and a difference signal d(t) between the input left signal IL(t) and the input right signal IR(t). In FIGS. 6A and 6B, “min” denotes a minimum value of a dynamic range and “max” denotes a maximum value of the dynamic range.

Referring to FIGS. 6A and 6B, the dynamic compression is applied to the input left signal IL(t) and the input right signal IR(t) between times t1 and t2.

FIG. 6C shows the difference signal d(t) extracted by using the input left signal IL(t) and the input right signal IR(t) shown in FIGS. 6A and 6B. As shown in FIG. 6C, an amplitude value of the difference signal d(t) between the times t1 and t2 is almost 0. Accordingly, the difference signal d(t) needs to be compensated for.

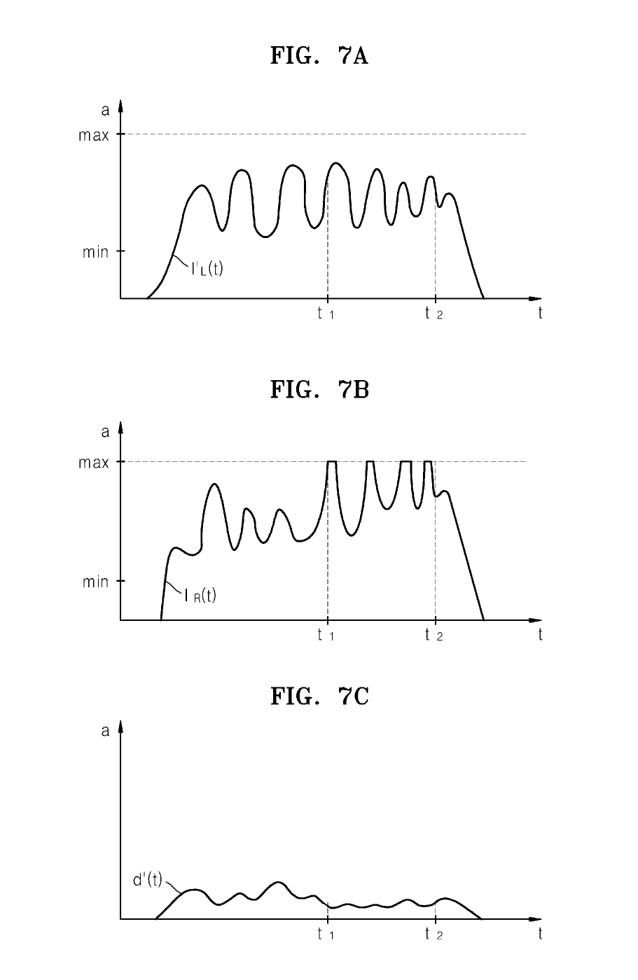

FIGS. 7A through 7C are diagrams for describing a method of compensating for a difference signal d(t), according to another embodiment of the present invention.

Referring to FIG. 2, the extractor 110 may include a determiner (not shown) and a filter unit (not shown). First, the determiner determines whether an amplitude value of the difference signal d(t) between the input left signal IL(t) and the input right signal IR(t) is 0. If the amplitude value of the difference signal d(t) is 0, it is determined whether amplitude values of the input left signal IL(t) and the input right signal I_{R}(t) correspond to a maximum or minimum value of a dynamic range.

For example, when the dynamic range of the input left signal I_{L}(t) and input right signal I_{R}(t) is −255 to 255, and the amplitude values of the input left signal I_{L}(t) and input right signal I_{R}(t) are both 255, the amplitude value of the difference signal d(t) is 0.

Next, if the amplitude values of the input left signal I_{L}(t) and input right signal I_{R}(t) correspond to the maximum or minimum value of the dynamic range, the filter unit may smoothen at least one of the input left signal I_{L}(t) and the input right signal I_{R}(t), and extract a difference signal d′(t) between the input left signal I_{L}(t) and the input right signal I_{R}(t).

The filter unit may be a smoothing filter, and may smoothen the entire or some of at least one of the input left signal I_{L}(t) and the input right signal I_{R}(t). The smoothing filter removes noise of data by using an average value of the data.

FIG. 7A shows a smoothened input left signal kV) and FIG. 7B shows the input right signal I_{R}(t). Only the input left signal I_{L}(t) is smoothened in FIG. 7A, but alternatively, only the input right signal I_{R}(t) may be smoothened, and both of the input left signal I_{L}(t) and input right signal I_{R}(t) may be smoothened. Referring to FIG. 7A, an amplitude value of the smoothened input left signal I_{L}′(t) between times t₁ and t₂ is smaller than a maximum value.

FIG. 7C is a graph of the difference signal d′(t) between the smoothened input left signal I_{L}′(t) and the input right signal I_{R}(t).

Referring to FIG. 7C, the amplitude value of the difference signal d′(t) is compensated for the times t₁ and t₂ to which dynamic compression is applied.

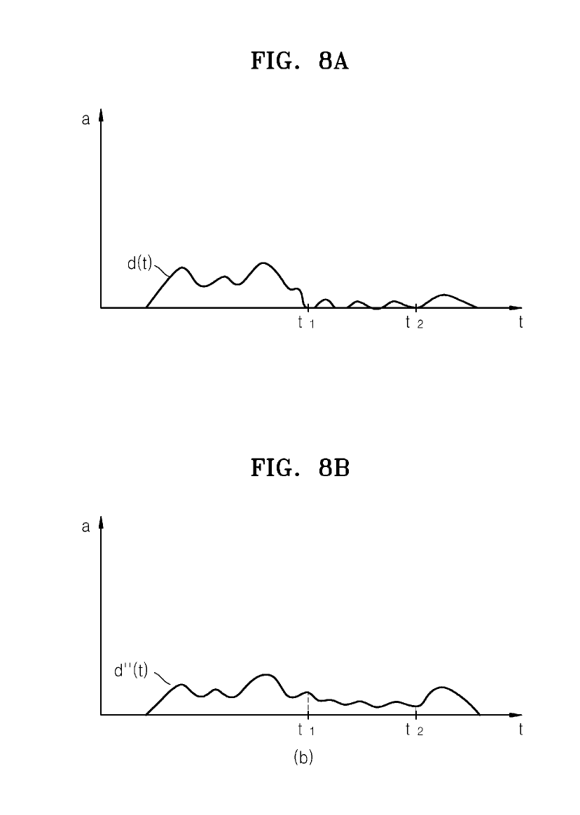

FIGS. 8A and 8B are diagrams for describing a method of compensating for a difference signal d(t), according to another exemplary embodiment.

As described above, the determiner determines whether the amplitude value of the difference signal d(t) between the input left signal I_{L}(t) and the input right signal I_{R}(t) is 0. If the amplitude value of the difference signal d(t) is 0, the determiner determines whether the amplitude values of the input left signal I_{L}(t) and input right signal I_{R}(t) correspond to the maximum or minimum value of the dynamic range.

Next, if the amplitude values of the input left signal I_{L}(t) and input right signal I_{R}(t) correspond to the maximum or minimum value of the dynamic range, the filter unit smoothens the difference signal d(t) between the input left signal I_{L}(t) and the input right signal I_{R}(t).

FIG. 8A is a graph of the difference signal d(t) between the input left signal I_{L}(t) and the input right signal I_{R}(t), to which dynamic compression is applied, wherein the amplitude value of the difference signal d(t) is almost 0 during times t₁ to t₂.

FIG. 8B is a graph of a difference signal d″(t) obtained by smoothening and compensating for the difference signal d(t) of FIG. 8A, wherein an amplitude value of the difference signal d″(t) is compensated during the times t₁ and t₂.

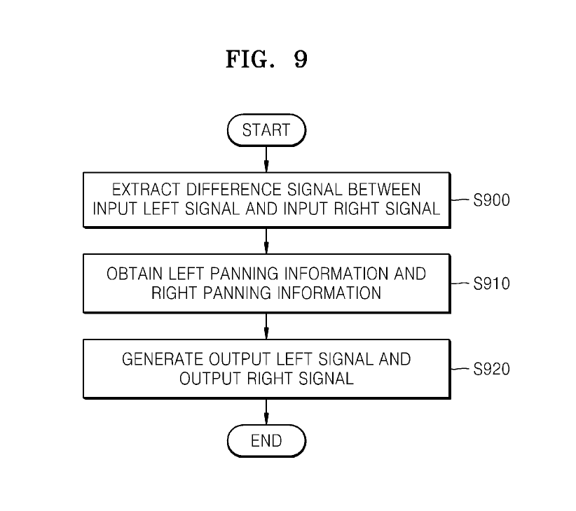

FIG. 9 is a flowchart illustrating a method of removing a vocal signal, according to an exemplary embodiment. Referring to FIG. 9, the method according to the current embodiment includes operations processed in time series by the apparatus 100 of FIG. 2. Accordingly, the same details described with reference to the apparatus 100 of FIG. 2 also apply to the method of FIG. 9.

In operation S900, the apparatus 100 extracts the difference signal d(t) between the input left signal I_{L}(t) and the input right signal I_{R}(t) of the stereo signal. The stereo signal may be stored in the apparatus 100 or received from an external server via wired or wireless communication.

In operation S910, the apparatus 100 obtains the left panning information from the input left signal I_{L}(t) and the right panning information from the input right signal I_{R}(t).

In operation S920, the apparatus 100 generates the output left signal O_{L}(t) by applying the left panning information to the difference signal d(t), and the output right signal O_{R}(t) by applying the right panning information to the difference signal d(t).

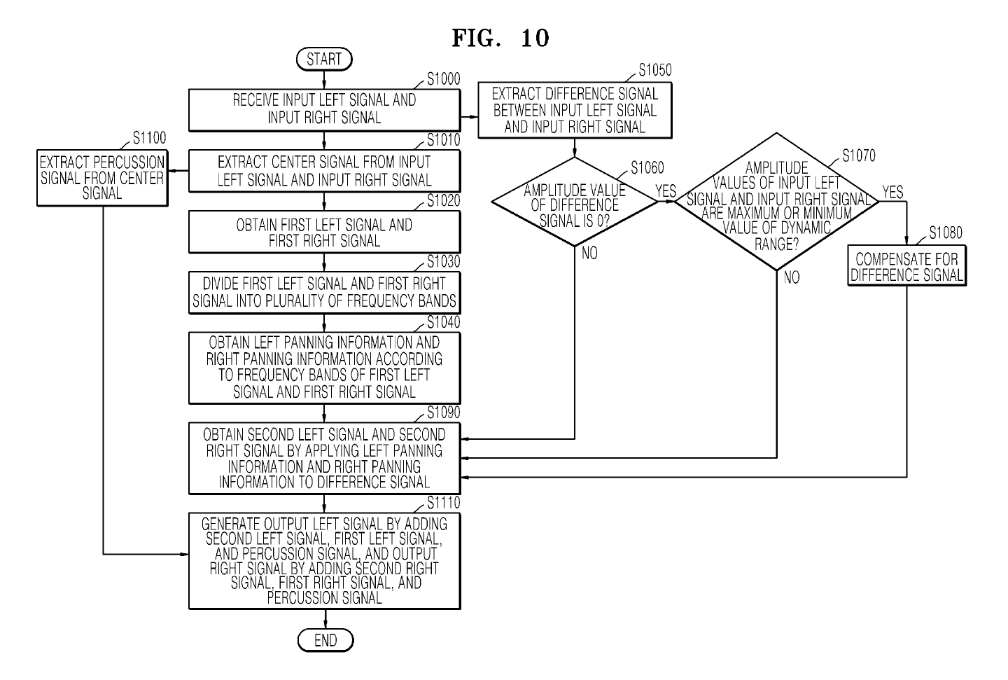

FIG. 10 is a flowchart illustrating a method of removing a vocal signal, according to another embodiment of the present invention. Operations of the method of FIG. 10 may be performed by the apparatus 300 of FIG. 4 in time series.

In operation S1000, the apparatus 300 receives the input left signal I_{L}(t) and the input right signal I_{R}(t) of the stereo signal.

Then, in operation S1010, the apparatus 300 extracts the center signal m(t) from the input left signal I_{L}(t) and input right signal I_{R}(t).

In operation 1020, the apparatus 300 obtains the first left signal l′(t) constituting the difference signal between the input left signal I_{L}(t) and the center signal m(t), and the first right signal r′ (t) constituting the difference signal between the input right signal I_{R}(t) and the center signal m(t).

In operation S1030, the apparatus 300 divides each of the first left signal l′(t) and the first right signal r′(t) into a plurality of frequency bands. The apparatus 300 may divide each of the first left signal l′(t) and the first right signal r′(t) into the frequency bands after converting the first left signal l′(t) and the first right signal r′(t) to the frequency domain.

In operation S1040, the apparatus 300 obtains the left panning information and the right panning information according to the frequency bands of the first left signal l′(t) and the first right signal r′(t).

In operation S1050, the apparatus 300 extracts the difference signal d(t) between the input left signal I_{L}(t) and the input right signal I_{R}(t).

In operation S1060, the apparatus 300 determines whether the amplitude value of the difference signal d(t) is 0.

If the amplitude value of the difference signal d(t) is 0, the apparatus 300 determines whether the amplitude values of the input left signal I_{L}(t) and the input right signal I_{R}(t) correspond to the maximum or minimum value of the dynamic range, in operation S1070.

If the amplitude values of the input left signal I_{L}(t) and input right signal I_{R}(t) correspond to the maximum or minimum value of the dynamic range, the apparatus 300 compensates for the difference signal d(t) in operation S1080. The apparatus 300 smoothens at least one of the input left signal I_{L}(t) and the input right signal I_{R}(t), and extracts the difference signal d(t) from the input left signal I_{L}(t) and the input right signal I_{R}(t), thereby compensating for the difference signal d(t). Alternatively, the difference signal d(t) is compensated by smoothening the difference signal d(t) between the input left signal I_{L}(t) and the input right signal I_{R}(t).

In operation S1090, the apparatus 300 obtains the second left signal l″(t) and the second right signal r″(t) by applying the left panning information and the right panning information to the difference signal d(t) or the compensated difference signal d(t).

In operation S1100, the apparatus 300 may extract the percussion signal p(t) from the center signal m(t).

In operation S1110, the apparatus 300 generates the output left signal O_{L}(t) by adding the second left signal l″(t), the first left signal l′(t), and the percussion signal p(t), and the output right signal O_{R}(t) by adding the second right signal r″(t), the first right signal r′(t), and the percussion signal p(t). The first left signal l′(t) and the first right signal r′(t) may be added at predetermined ratios.

The embodiments of the present invention can be written as computer programs and can be implemented in general-use digital computers that execute the programs using a computer-readable recording medium. Examples of the computer-readable recording medium include magnetic storage media (e.g., ROM, floppy disks, hard disks, etc.), optical recording media (e.g., CD-ROMs, or DVDs), etc.

While exemplary embodiments have been particularly shown and described, it will be understood by one of ordinary skill in the art that various changes in form and details may be made therein without departing from the spirit and scope of the inventive concept as defined by the appended claims. The embodiments should be considered in a descriptive sense only and not for purposes of limitation. Therefore, the scope of the inventive concept is defined by the appended claims, and all differences within the scope will be construed as being included in the present inventive concept.

What is claimed is:

1. A method of removing a vocal signal, the method comprising:
extracting a difference signal which is a difference between an input left signal and an input right signal of a stereo signal;
obtaining left panning information of the input left signal from the input left signal, and obtaining right panning information of the input right signal from the input right signal; and
generating an output left signal by applying the left panning information to the difference signal, and generating an output right signal by applying the right panning information to the difference signal, such that the output left signal and the output right signal are signals from which the vocal signal has been removed.

2. The method of claim 1, wherein:
the obtaining the left panning information comprises dividing the input left signal into a plurality of frequency bands in a frequency domain; and obtaining the left panning information according to the plurality of frequency bands of the input left signal; and
the obtaining the right panning information comprises dividing the input right signal into a plurality of frequency bands in the frequency domain and obtaining the right panning information according to the plurality of frequency bands of the right input signal.

3. The method of claim 2, wherein:
the generating the output left signal comprises generating the output left signal by applying the left panning information to the difference signal according to the plurality of frequency bands of the difference signal, and
the generating the output right signal comprises generating the output right signal by applying the right panning information to the difference signal according to the plurality of frequency bands of the difference signal.

4. The method of claim 1, further comprising:
extracting a center signal of the stereo signal by using a cross correlation between the input left signal and the input right signal, the input left signal, and the input right signal;
wherein the obtaining the left panning information comprises obtaining a first left signal which is a difference signal between the input left signal and the center signal, dividing the first left signal into a plurality of frequency bands in a frequency domain, and obtaining the left panning information according to the plurality of frequency bands of the first left signal; and
wherein the obtaining the right panning information comprises obtaining a first right signal which is a difference signal between the input right signal and the center signal, dividing the first right signal into a plurality of frequency bands in the frequency domain, and obtaining the right panning information according to the plurality frequency bands of the first right signal.

5. The method of claim 4, wherein:
the generating the output left signal comprises generating a second left signal by applying the left panning information to the difference signal according to a plurality of frequency bands of the difference signal, and generating the output left signal by adding the first left signal to the second left signal at a predetermined ratio; and
the generating the output right signal comprises generating a second right signal by applying the right panning information to the difference signal according to the plurality of frequency bands of the difference signal, and generating the output right signal by adding the first right signal to the second right signal at a predetermined ratio.

6. The method of claim 4, further comprising extracting a percussion signal from the center signal,
wherein the generating the output left signal and the generating the output right signal comprise comprises generating the output left signal by adding the percussion signal to a signal output by applying the left panning information to the difference signal according to a plurality of frequency bands of the difference signal, and generating the output right signal by adding the percussion signal to a signal output by applying the right panning information to the difference signal according to the plurality of frequency bands of the difference signal.

7. The method of claim 6, wherein the extracting the percussion signal comprises:
obtaining an intermediate value of an amplitude value of the center signal; and
extracting, as the percussion signal, a signal having an amplitude value higher than the intermediate value from among the center signal in the time domain, or extracting a signal having an amplitude value smaller than the intermediate value from among the center signal in the frequency domain.

8. The method of claim 1, wherein the extracting the difference signal comprises:
determining whether an amplitude value of the difference signal is 0;
if the amplitude value of the difference signal is 0, determining whether amplitude values of the input left signal and the input right signal correspond to a maximum or minimum value of a dynamic range;
if the amplitude values of the input left signal and the input right signal correspond to the maximum or minimum value of the dynamic range, applying at least one of the input left signal and the input right signal to a smoothing filter; and
extracting a difference signal between the input left signal and the input right signal.

9. The method of claim 1, wherein the extracting the difference signal comprises:
determining whether an amplitude value of the difference signal is 0;
if the amplitude value of the difference signal is 0, determining whether amplitude values of the input left signal and input right signal correspond to a maximum or minimum value of a dynamic range; and
if the amplitude values of the input left signal and input right signal correspond to the maximum or minimum value of the dynamic range, applying the difference signal to a smoothing filter.

10. The method of claim 1, wherein the obtaining the left panning information comprises obtaining the left panning information by applying at least one of autoregressive processing, linear predictive coding, and principal component analysis to the input left signal and the obtaining the right panning information comprises obtaining the right panning information by applying at least one of autoregressive processing, linear predictive coding, and principal component analysis to the input right signal.

11. An apparatus for removing a vocal signal, the apparatus comprising:
an extractor which extracts a difference signal which is a difference between an input left signal and an input right signal of a stereo signal;
an information obtainer which obtains left panning information of the input left signal from the input left signal, and obtains right panning signal of the input right signal from the input right signal; and
an output unit which generates an output left signal by applying the left panning information to the difference signal, and generates an output right signal by applying the right panning information to the difference signal.

12. The apparatus of claim 11, wherein the information obtainer comprises:
a frequency band divider which divides the input left signal into a plurality of frequency bands in a frequency domain and divides the input right signal into a plurality of frequency bands in the frequency domain; and
a panning information obtainer which obtains the left panning information according to the plurality of frequency bands of the input left signal and obtains the right panning information according to the plurality of frequency bands of the input right signal.

13. The apparatus of claim 12, wherein the output unit generates the output left signal by applying the left panning information to the difference signal according to the plurality of frequency bands of the difference signal, and generates the output right signal by applying the right panning information to the difference signal according to the plurality of frequency bands of the difference signal.

14. The apparatus of claim 11, wherein the information obtainer extracts a center signal of the stereo signal by using a cross correlation between the input left signal and the input right signal, the input left signal, and the input right signal, and wherein the apparatus further comprises:
a center signal remover which obtains a first left signal which is a difference signal between the input left signal and the center signal, and obtains a first right signal which is a difference signal between the input right signal and the center signal;
a frequency band divider which divides the first left signal into a plurality of frequency bands in a frequency domain and which divides the first right signal into a plurality of frequency bands in the frequency domain; and
a panning information obtainer which obtains the left panning information according to the plurality of frequency bands of the first left signal and obtains the right panning information according to the plurality of frequency bands of the first right signal.

15. The apparatus of claim 14, wherein the output unit comprises:
a panning information applier which generates a second left signal by applying the left panning information to the difference signal according to the plurality of frequency bands of the difference signal, and generates a second right signal by applying the right panning information to the difference signal according to the plurality of frequency bands of the difference signal; and
an adder-subtractor which generates the output left signal by adding the first left signal to the second left signal at a predetermined ratio, and which generates the output right signal by adding the first right signal to the second right signal at a predetermined ratio.

16. The apparatus of claim 14, wherein the center signal remover comprises a percussion signal extractor which extracts for extracting a percussion signal from the center signal,
wherein the output unit comprises an adder-subtractor which generates the output left signal by adding the percussion signal to a signal output by applying the left panning information to the difference signal according to the plurality of frequency bands of the difference signal, and generates the output right signal by adding the percussion signal to a signal output by applying the right panning information to the difference signal according to the plurality of frequency bands of the difference signal.

17. The apparatus of claim 16, wherein the percussion signal extractor obtains an intermediate value of an amplitude value of the center signal, and extracts, as the percussion signal, a signal having an amplitude value higher than the intermediate value from the center signal in the time domain, or a signal having an amplitude value smaller than the intermediate value from the center signal in the frequency domain.

18. The apparatus of claim 11, wherein the extractor comprises:
a determiner which determines whether an amplitude value of the difference signal is 0, and if the amplitude value of the difference signal is 0, determines whether amplitude values of the input left signal and input right signal correspond to a maximum or minimum value of a dynamic range; and
a filter unit which, if the amplitude values of the input left signal and input right signal correspond to the maximum or minimum value of the dynamic range, smoothes at least one of the input left signal and the input right signal, and extracts a difference signal between the input left signal and the input right signal.

19. The apparatus of claim 11, wherein the extractor comprises:
a determiner which determines whether an amplitude value of the difference signal is 0, and if the amplitude value of the difference signal is 0, determines whether amplitude values of the input left signal and input right signal correspond to a maximum or minimum value of a dynamic range; and
a filter unit which, if the amplitude values of the input left signal and input right signal correspond to the maximum or minimum value of the dynamic range, smoothes the difference signal.

20. The apparatus of claim 11, wherein the information obtainer obtains the left panning information by applying at least one of autoregressive processing, linear predictive coding, and principal component analysis to the input left signal and obtains the right panning information by applying at least one of autoregressive processing, linear predictive coding, and principal component analysis to the input right signal.

21. A computer-readable recording medium having recorded thereon a program for executing a method comprising:
extracting a difference signal which is a difference between an input left signal and an input right signal of a stereo signal;
obtaining left panning information of the input left signal from the input left signal and obtaining right panning information of the input right signal from the input right signal; and
generating an output left signal by applying the left panning information to the difference signal, and generating an output right signal by applying the right panning information to the difference signal.

22. The method of claim 1, wherein the input left signal is an input left front signal of a multi-channel signal or an input left surround signal and the input right signal is an input right front signal of the multi-channel signal or an input right surround signal.

23. The method of claim 1, wherein the input left of the stereo signal is an input left front signal of a multi-channel signal, the input right signal of the stereo signal is an input right front signal of the multi-channel signal, and the method further comprises removing a signal of a predetermined frequency range included in a center channel signal of the multi-channel signal by applying a bandpass filter to the center channel signal.
